(19) United States
(12) Patent Application Publication
(10) Pub. No.: US 2025/0348526 A1
(43) Pub. Date: Nov. 13, 2025

(54) Exposing App Functionality using System-level LLM Agent Services

(71) Applicant: Google LLC, Mountain View, CA (US)

(72) Inventors: Eugenio Jorge Marchiori, Tres Cantos (ES); Sergei Volnov, London (GB); Felix Oghina, London (GB); Mark Koty White, London (GB); Abodunrinwa Toki, London (GB); Ali Hamdi Cevik, London (GB); Bernardo Monteiro Rufino, Waltham Cross (GB); Kalyana Ram Desineni, San Jose, CA (US)

(21) Appl. No.: 19/205,986

(22) Filed: May 12, 2025

Related U.S. Application Data
(60) Provisional application No. 63/646,426, filed on May 13, 2024.

(51) Int. Cl. G06F 16/334; G06F 9/54; G06F 40/30

(52) U.S. Cl. CPC G06F 16/334; G06F 9/547; G06F 40/30

(57) ABSTRACT

This document describes systems and techniques directed at exposing application functionality using system-level large language model (LLM) agent services. An electronic device accesses one or more LLMs. An input prompt is received, the input prompt including a plurality of words in a natural-language format. The input prompt is used as an input for the one or more LLMs, which generates an inference output indicative of an intent of the input prompt. An action output is performed based on the intent of the input prompt. An application agent instantiated within an application interface generates the input prompt, parses the input prompt, receives the input prompt, or limits the action output.

### CROSS-REFERENCE TO RELATED DISCLOSURE

This application claims priority to U.S. Provisional Patent Application No. 63/646,426, filed May 13, 2024, which is incorporated herein by reference in its entirety.

### BACKGROUND

Electronic devices may greatly benefit from digital assistants, especially those leveraging functionality of applications (apps) accessible to the electronic device. The advent of artificial intelligence (AI), particularly large language models (LLMs), allows digital assistants to parse natural language, thus improving user experience, immersion, and the overall functionality of the electronic device. However, the functionality of digital assistants is hampered by their inability to intelligently deploy application functions in a variety of settings. For example, accessing a digital assistant may force a user to leave an application they were interfacing with, thus losing some of the utility of, and immersion in, the application. Further, implementing digital assistant functionality may be cumbersome to application developers and overly limited based on application sandboxing, thus disincentivizing application developers from incorporating useful features from digital assistants in their applications.

### SUMMARY

This document describes systems and techniques directed at exposing application functionality using system-level LLM agent services. Various examples are described herein, including a method that includes receiving, by one or more processors, an input prompt. The input prompt includes a plurality of words in a natural-language format. The input prompt is provided, by the one or more processors, as an input for one or more LLMs. The one or more processors receive an inference output of the one or more LLMs based on the input prompt and are configured to determine an intent of the input prompt. The one or more processors generate an action output based on the determined intent of the input prompt. The device performs the action output. In some examples, the input prompt is a user-generated input prompt, generated at least in part by the one or more LLMs, or a user-selected input prompt from a plurality of available input prompts. In some examples, the action output is generated by the one or more LLMs.

In some examples, the one or more processors access an application and generate an application agent. The application agent is based on one or more parameters of the application and is instantiated within the application. The instantiation includes an interface within the application. In some examples, the receiving of the input prompt is performed by the application agent. The action output, in some examples, includes at least one functionality of at least one outside application, the outside application being different than the application in which the application agent is instantiated. In some examples, the one or more processors generate a second output based on the action output. The second output is configured to be output to a user through the application agent.

In some examples, the one or more processors access a second application and generate a second application agent. The second application agent is based on one or more parameters of the second application and is instantiated within the second application. The instantiation includes an interface within the second application, and the interface within the second application includes the application agent.

This Summary is provided to introduce simplified concepts for exposing application functionality using system-level LLM agent services, which is further described below in the Detailed Description and is illustrated in the Drawings. This Summary is intended neither to identify essential features of the claimed subject matter nor for use in determining the scope of the claimed subject matter.

### BRIEF DESCRIPTION OF THE DRAWINGS

The details of one or more aspects of systems and techniques for exposing application functionality using system-level LLM agent services are described in this document with reference to the following drawings:

FIG. 1 illustrates an example environment in which techniques for exposing application functionality using system-level LLM agent services can be implemented;

FIG. 2 illustrates an example operating environment of an example user device capable of implementing aspects of exposing application functionality using system-level LLM agent services;

FIG. 3 illustrates an example block diagram directed at implementing exposing application functionality using system-level LLM agent services;

FIG. 4 illustrates an example block diagram directed at interface elements for exposing application functionality using system-level LLM agent services;

FIG. 5 illustrates an example application interface with an example instantiated application agent;

FIG. 6 illustrates an example training environment for an LLM, such as one used in exposing application functionality using system-level LLM agent services;

FIG. 7 illustrates an example transformer used for training an LLM, as outlined in this disclosure;

FIG. 8 illustrates an example transformation in a language space;

FIG. 9 illustrates an example of fine-tuning an LLM to produce a fine-tuned LLM;

FIG. 10 illustrates an example outline for prompt engineering within an LLM; and

FIG. 11 illustrates an example method for exposing application functionality using system-level LLM agent services.

FIG. 12 illustrates an example method for exposing application functionality using system-level LLM agent services in accordance with one or more implementations.

FIG. 13 illustrates an example method for exposing application functionality using system-level LLM agent services in accordance with one or more implementations.

FIG. 14 illustrates an example method for exposing application functionality using system-level LLM agent services in accordance with one or more implementations.

The use of same numbers in different instances may indicate similar features or components.

### DETAILED DESCRIPTION

### Overview

User interaction and manipulation of electronic devices is generally limited to the functionality built in by device and application programmers. Further, application functions are generally relegated to operation within the context of an application in which they reside. Attempts to overcome these limitations include a system agent, which attempts to connect a user to various abilities of installed applications. However, this takes the user out of an interface of the application and further does nothing to solve the problem of the user being unable to execute novel routines on the electronic device.

To this end, this document describes techniques and systems for exposing application functionality using system-level large language model (LLM) agent services. The techniques and systems use a system-level agent employing LLM functionality. The LLM allows the user to interact with the device in a natural-language input setting, entering input prompts into the LLM via the system-level agent by simply speaking, typing or other natural input languages. Further, the system is able to instantiate the system-level agent within the context and interface of an application, allowing for the application functionality, permission set, and user data to be accessed and leveraged by the LLM without the user exiting the application. A second application may also have its functionality, permissions, and associated user data accessed by the system-level agent within the first application, as well as have a second instantiation of the system-level agent within the context and interface of the second application. The techniques provide users with greater usability of both the device and the applications installed on the device.

### Operating Environment

The following discussion describes an operating environment, techniques that may be employed in the operating environment, and various devices or systems in which components of the operating environment can be embodied. In the context of the present disclosure, reference is made to the operating environment by way of example only.

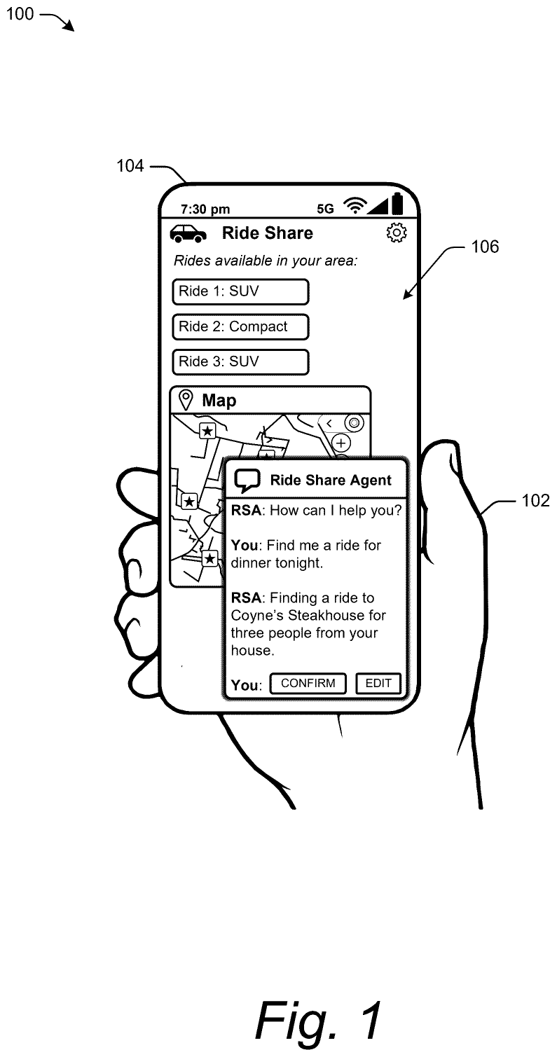

FIG. 1 illustrates an example environment 100 in which techniques for exposing application functionality using system-level LLM agent services may be implemented. Generally, the environment 100 includes a user 102 and a device 104. The device 104 includes an interface 106, shown in FIG. 1 as an application interface on a display of the device 104. The interface 106 allows the user 102 to interact with the device 104, including interaction with applications stored on the device 104, interaction with one or more functions of an operating system (OS) of the device 104, and interaction with other devices, which may be connected to the device 104.

The example device 104 in FIG. 1 is a mobile phone, in which case interaction from the user 102 takes the form of touching the display, speaking into one or more microphones, or other interactions common to mobile phones. The interface 106 is shown as displaying an application with an instantiated agent, which the user 102 may interact with through the interface 106 based on the native capabilities of the device 104. By way of example, the user 102 touches the interface 106 to access touch-activated features of the application or instantiated agent.

### Example Devices

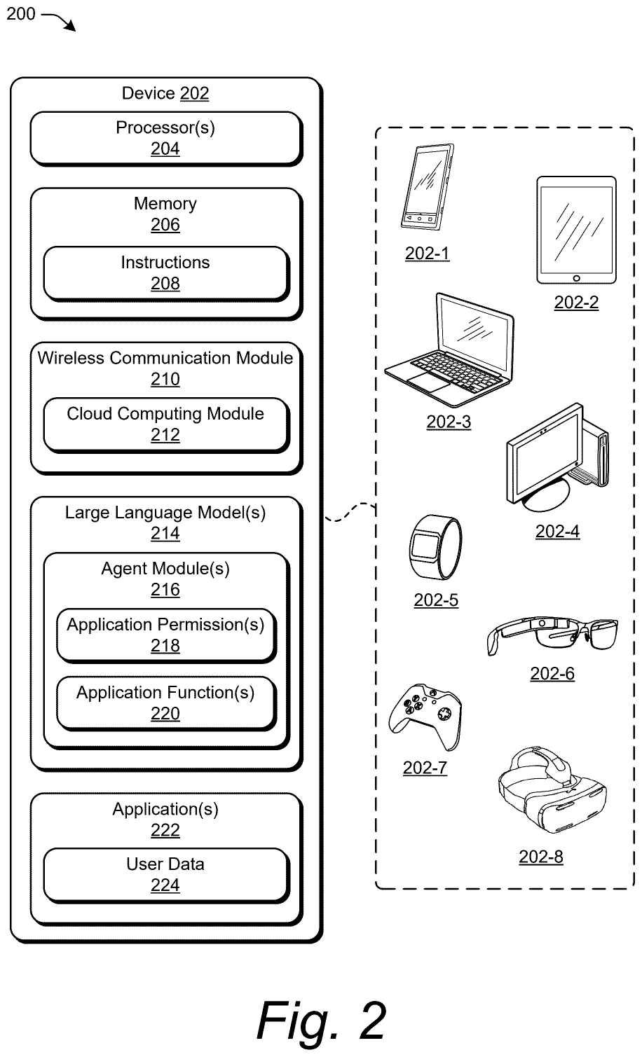

FIG. 2 illustrates an example operating environment 200 of an example user device 202 (e.g., device 104) capable of implementing aspects of exposing application functionality using system-level LLM agent services in accordance with one or more implementations. Examples of the user device 202 include a smartphone 202-1, a tablet 202-2, a laptop 202-3, a desktop computer 202-4, a smart watch 202-5, smart-glasses 202-6, a video game console 202-7, and virtual-reality (VR) goggles 202-8. Although not shown, the user device 202 may also be implemented as any of a mobile communication device, a client device, a home automation and control system, an entertainment system, a personal media device, a health monitoring device, a drone, a camera, an Internet home appliance capable of wireless Internet access and browsing, an IoT device, security systems, and the like. Note that the user device 202 can be wearable, non-wearable but mobile, or relatively immobile (e.g., appliances). The user device 202 may include components or interfaces omitted from FIG. 2 for the sake of clarity or visual brevity.

As illustrated, the user device 202 includes one or more processors 204 and a memory 206. The processors 204 may include any suitable single-core or multi-core processor (e.g., an application processor (AP), a digital-signal processor (DSP), a central processing unit (CPU), a graphics processing unit (GPU), etc.). The processors 204 may be configured to execute instructions 208 or commands stored within the memory 206. The memory 206 may include one or more non-transitory storage devices such as a random access memory (RAM, dynamic RAM (DRAM), non-volatile RAM (NVRAM), static RAM (SRAM), etc.), a read-only memory (ROM), a flash memory, a hard drive, a solid-state drive (SSD), or any type of media suitable for storing electronic instructions, each coupled with a computer system bus. The term “coupled” may refer to two or more elements that are in direct contact (physically, electrically, magnetically, optically, etc.) or to two or more elements that are not in direct contact with each other but still cooperate and/or interact with each other.

The user device 202 may further include and/or be operatively coupled to a wireless communication module 210. The wireless communication module 210 may enable communication of device data, such as received data, transmitted data, or other information as described herein, and may provide connectivity to one or more networks and other devices connected therewith. Examples of the wireless communication module 210 include near field communications (NFC) transceivers, wireless personal area network (WPAN) radios compliant with various IEEE 802.15 (Bluetooth®) standards, wireless local area network (WLAN) radios compliant with any of various IEEE 802.11 (WiFi®) standards, wireless wide area network (WWAN) (3GPP-compliant) radios for cellular telephony, wireless metropolitan area network (WMAN) radios compliant with various IEEE 802.16 (WiMAX®) standards, infrared (IR) transceivers compliant with an Infrared Data Association (IrDA) protocol, and wired local area network (LAN) Ethernet transceivers. Device data communicated over the wireless communication module 210 may be packetized or framed depending on a communication protocol or standard by which the user device 202 is communicating. The wireless communication module 210 may include interfaces for communication over a local network, a private network, an intranet, the Internet, or wireless networks, such as WLANs, cellular networks, or WPANs.

The wireless communication module 210 may include a cloud computing module 212. The cloud computing module 212 enables communication with cloud computing devices, such as remote servers, application engines stored remotely, functionalities accessed through an internet connection, etc. The cloud computing module 212 interfaces with remote devices (e.g., devices accessed through the internet) to provide functionality to the user device 202 and may be coupled to the processors 204, the memory 206, and/or other components of the user device 202.

The user device 202 may further include one or more large language models (LLMs) 214. The one or more LLMs 214 may be stored in the memory 206 of the user device 202 or stored in a memory of a connected device accessed through the wireless communication module 210 and/or the cloud computing module 212. In some examples, portions of the one or more LLMs 214 are stored in the memory 206 of the user device 202 and other portions of the one or more LLMs 214 are stored on a connected device. In some examples, one or more of the one or more LLMs 214 are stored in the memory 206 of the user device 202 and one or more of the one or more LLMs 214 are stored on a connected device. The one or more LLMs 214 may include one or more agent modules 216. The agent modules 216 access the capabilities of the one or more LLMs 214 and serve as functional instantiations of the one or more LLMs 214, as will be outlined later in this disclosure. The agent modules 216 include application permissions 218 and application functions 220. The application permissions 218 include allowed or restricted access features, such as data an application may or may not access, functions or resources of the user device 202 the application may or may not access, etc. The application functions 220 include the abilities and algorithms of the application. Each agent module 216 is associated with an individual application.

Although the agent modules 216 are shown as residing within the one or more LLMs 214, this is a statement of the functionality of the agent modules 216 leveraging the functionality of the one or more LLMs 214. It should be understood that the agent modules 216 may be stored in the memory 206 or may be generated by the processors 204 upon instantiation. In some examples, the agent modules 216 are not persistent in any memory, instead being generated on demand. In other examples, the agent modules 216 are persistent and may be stored for rendering to the user device 202 upon instantiation, such as stored in the memory 206. In some examples, the agent modules 216 are stored in a device connected by the wireless communication module 210, such as in a cloud computing device connected by the cloud computing module 212.

The user device 202 may further include one or more applications 222. The applications 222 may be stored in the memory 206 or in a device connected by the wireless communication module 210, such as in a cloud computing device connected by the cloud computing module 212. The applications 222 include user data 224. The user data 224 of one application of the applications 222 may be accessible by another application of the applications 222 based on the application permissions 218. Although the application permissions 218 and the application functions 220 are shown as residing within the agent modules 216, it should be understood that the application permissions 218 and the application functions 220 are based on the applications 222 and, thus, may equally be seen as residing within the applications 222.

### Example LLM and Agent Functionality

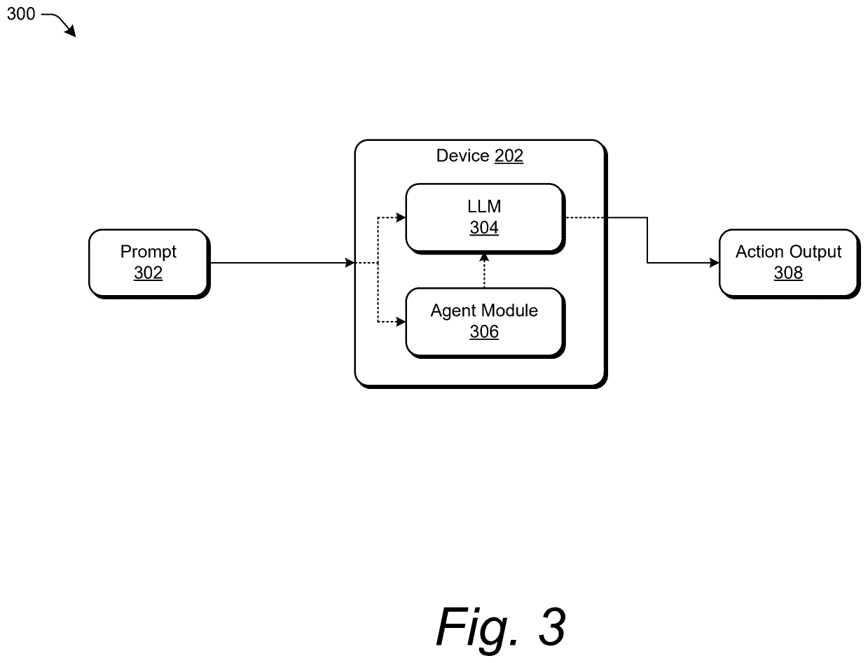

FIG. 3 illustrates an example block diagram 300 directed at implementing exposing application functionality using system-level LLM agent services. The block diagram 300 includes a prompt 302, an LLM 304, an agent module 306, and an action output 308. The LLM 304 and the agent module 306 are shown as residing in the user device 202 of FIG. 2, but this should not be seen as limiting. The LLM 304 may reside in a remote device, the agent module 306 may reside in the remote device, or both may reside in the remote device or in separate remote devices.

In aspects, the prompt 302 is used as an input for the LLM 304. In some examples, the prompt 302 is a user-generated prompt, such as “get me a dinner reservation for tonight.” In other examples, the prompt 302 is a preconfigured prompt, such as one of a plurality of preconfigured input prompts from which a user may select. The preconfigured prompts may be user-generated, provided by an application, provided by an operating system, or provided by other users. The prompt 302, in some examples, is generated by the LLM 304. In such examples, the LLM 304 may predict a desired action output 308 and generate or suggest the prompt 302, which may be predicted to provide the desired action output 308. In some examples, the prompt 302 is a product of a prompt engineering. The prompt engineering may be provided by the user, the application, the operating system, etc. In other examples, the prompt 302 is generated by the agent module 306. Although FIG. 3 illustrates a single LLM, multiple LLMs may be equally employed.

In some examples, the prompt 302 may be stored for future use (e.g., stored in the memory 206). For example, the user may enter the prompt 302 in order to produce a desired action by the user device 202. If the action output 308 matches an intent of the prompt 302, the user may wish to re-use the prompt 302. For example, suppose the user generates a prompt 302 of the form “make it look like I'm home tonight,” with the resultant action output 308 being the user device 202 directing a connected home-automation device to set lights of a home of the user to turn on in the evening and turn off at a normal bedtime of the user, turn a television on at a usual time, etc. In such an example, the user may wish to re-use the prompt 302. The prompt 302 may be automatically stored or stored based on a request from the user.

In some examples, the prompt 302 is used as an input for the agent module 306. In such examples, the prompt 302 may take any form or technique described above in reference to the prompt 302 being used as an input for the LLM 304. The agent module 306 may, in some examples, parse the prompt 302 prior to generating an input for the LLM 304. The parsing of the prompt 302 by the agent module 306 may include application-specific attributes, such as application permissions (e.g., the application permissions 218) and application functions (e.g., the application functions 220). By way of example, consider an application associated with the agent module 306, the application not having permission to access messaging data of a user. In such an example, suppose the application is a shopping application and the prompt 302 is of the form “find a good gift for my friend Joe.” In this example, the user may have had a messaging conversation with Joe where Joe expressed interest in a particular item, and the particular item is available on the shopping application. If the prompt 302 is used as an input for the LLM 304 without any permission information or limitations, the LLM 304 might attempt to use the messaging data indicating that Joe wants the particular item found in the shopping application. However, the agent module 306 having the application permissions showing the shopping application does not have access to the messaging data and therefore does not generate an input for the LLM 304 asking to access the messaging data.

The prompt 302, in aspects, is a request for the user device 202 to perform an action, such as performing a functionality of the application. The LLM 304, either directly or through the agent module 306, parses the prompt 302 and generates the action output 308. This parsing, in aspects, determines the intent of the prompt 302. By way of example, consider a prompt 302 of the form “create a meeting based on this conversation.” The prompt 302 of this form implies the intent of having a meeting pertaining to the contents of the conversation. The intent includes parameters such as members of the conversation, subjects discussed in the conversation, action items, a user schedule and/or schedules of other people in the conversation, etc. The LLM 304 derives the intent from the prompt 302 and creates the action output 308. In this example, the action output 308 may be to interface with a calendar application on the user device 202 and set a meeting on a free date with details and participants derived from the conversation. In some examples, the agent module 306 determines the intent of the prompt 302.

The action output 308, in aspects, may take many forms. The previous example outlined the action output 308 taking the form of an application action, but other forms are possible. For example, the action output 308 may be a function of the LLM 304, such as generation of a new prompt 302. In other examples, the action output 308 may take the form of performing a function of the user device 202. In another example, the action output 308 may take the form of creating an interface for the user, the interface configured to allow the user to interact with various components, such as one or more applications stored on the user device 202, one or more cloud applications, a second application, etc. In such cases, as the user is interacting through the user device 202, the user device 202 performs the action output 308.

In some examples, the action output 308 is an executable code. For example, consider a routine created by the LLM 304 based on the intent of the prompt 302. The routine may be an algorithm, such as the executable code. In this way, the user may create a novel code for the user device 202, associated applications, or other components. The executable code may be stored for future use (e.g., stored in the memory 206). In some examples, the prompt 302 may be determined by the LLM 304 to have an intent substantially similar to a past intent, where the generation of the executable code is based at least in part on the past intent. In such examples, the action output 308 may be the executable code, without having the LLM 304 re-generate the executable code or generate another executable code. In aspects, such a determination by the LLM 304 that the intent of the prompt 302 matches the past intent associated with the executable code may involve the LLM 304 generating a comparison value for the correspondence of the intent with the past intent associated with the executable code. Such a comparison value may be compared with a threshold value to determine if the executable code should be retrieved and used as the action output 308.

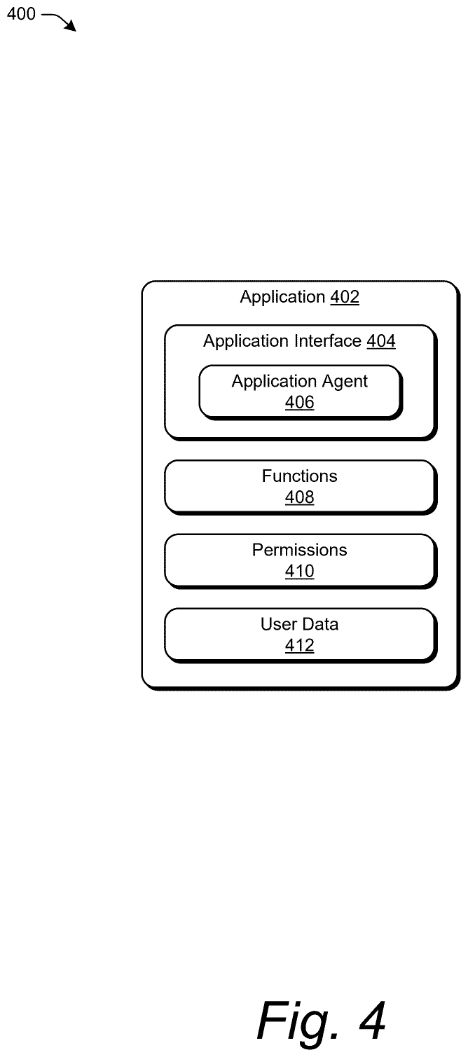

FIG. 4 illustrates an example block diagram 400 directed at interface elements for exposing application functionality using system-level LLM agent services. In aspects, a user may interact with a device (e.g., the device 104), which may include an application 402 (e.g., the application 222). The application 402 may include an application interface 404 to facilitate user interaction. For example, the application interface 404 may be in the form of a user interface (UI) element on a display of the device. In other examples, the application interface 404 may be an audio interface, such as through a speaker of the device. The user may interact with the application interface 404 using an input (not pictured), such as, but not limited to, a capacitive touchscreen, a keyboard, a mouse, a virtual or augmented reality input, a gaming controller, a motion capture device, etc.

In aspects, the application interface 404 may include an instantiation of an application agent 406 (e.g., the agent module 306, the agent module 216, etc.). In the example where the application interface 404 is rendered on a display element, the application agent 406 may be rendered to the display. In such examples, the application agent 406 may be rendered over the entire application interface 404 or over a partial portion of the application interface 404. In some examples, the application agent 406 may not be displayed even though it is instantiated, such as the application agent 406 instantiated as an audio-only interface.

Although the application agent 406 is instantiated within the application interface 404, this, as outlined previously, does not imply the application agent 406 is a product of or a part of the application 402. In some examples, the application 402 may invoke the application agent 406, such as through an in-app application programming interface (API) call. However, the invocation for the instantiation of the application agent 406 within the application interface 404 should not be construed as the application agent 406 being a part of the application 402. In aspects, the application agent 406 is a system-level agent, meaning the application agent 406 runs on the system of the device and not within the application 402. For instance, it is possible for the application agent 406 to be instantiated within the application interface 404 and to have a second application agent (not pictured) instantiated within a second application interface (not pictured) as an interface for a second application (not pictured). In such examples, the application agent 406 and the second application agent may be instances of a same functionality of the device and not separate entities, save in apparent functionality to the user. The application agent 406 and the second application agent may, in such examples, collaborate with one another, such as the second application agent instantiating in the application interface 404, the application agent 406 and the second application agent sharing data, etc.

In some examples, the application agent 406 is part of the application 402. For example, the application agent 406 may be a digital assistant. In such examples, the application agent 406 is integral to the application 402, such as the user accessing the digital assistant as the application 402. In aspects, the application agent 406 is a function of an operating system. In some examples, the application 402 is also part of the operating system. In such examples, integrating the application agent 406 with the application 402 includes the application agent 406 being part of the application 402. For example, the application 402 may be designed as a general gateway to the application agent 406, with the application agent 406 designed as part of the application 402.

The application 402 may further include one or more functions 408. Examples of the functions 408 include abilities of the application 402. For example, if the application 402 is a ride-sharing application, the functions 408 may include mapping capabilities, an ability to call a vehicle to the user, and location awareness. The application 402 may further include one or more permissions 410. Again using the example of the application 402 being a ride-sharing application, the permissions 410 may include access to a mapping application of the device, access to a global positioning satellite (GPS) sensor of the device, or similar accesses. In some examples, the permissions 410 may be negative permissions, indicating things the application 402 does not have access to. Again using the example where the application 402 is a ride-sharing application, the permissions 410 may indicate that the application 402 does not have access to a contact list, banking information, passwords outside of the application 402, etc.

The application 402 may further include user data 412. The user data 412 may include, for example, user preferences within the application, a use or entry history, payment information, etc. The user data 412 may be, in some examples, attached to the application 402. In some examples, the user data 412 may be stored on the device, in a remote device, or otherwise outside of the scope of the application 402. In such examples, the application 402 may have access to the user data 412 stored outside of the application 402 scope by way of the application permissions 410.

The application agent 406, in aspects, inherits the application functions 408, the application permissions 410, and the user data 412. By way of example, consider the application 402 in the form of a recipe application. Consider an example where the application permissions 410 indicate the recipe application does not have access to a camera of the device. The application agent 406, as outlined above, may not be a part of the application 402. For example, the application agent 406 may be part of the device operating system. In such an example, the operating system has access to the camera of the device and the application agent 406, in principle, is capable of accessing the camera of the device. However, in this example, the application 402 does not have the application permissions 410 to access the camera of the device (or, equally, the application permissions 410 may explicitly not allow access of the camera of the device by the application 402). In such an example, the application agent 406 instantiated within the application interface 404 is not able to access the camera of the device.

The application agent 406 having access to the application functions 408 may, in some examples, persist through other applications. For example, suppose the user is interfacing with the second application using the second application agent. The second application agent may be in contact with the application agent 406, allowing the user to access the functions 408 of the application 402 while interfacing with the second application.

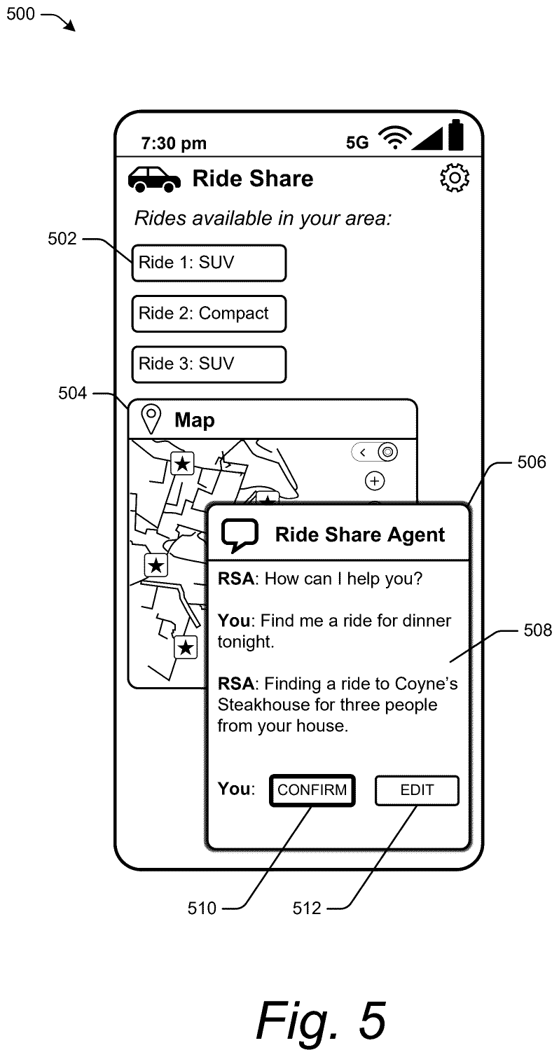

FIG. 5 illustrates an example application interface 500 with an instantiated application agent. The example application interface 500 (e.g., the application interface 404) is for a ride-sharing application. The application interface 500 may include elements of the application indicating application functions (e.g., the functions 408), such as available rides 502 and a map 504. The application interface 500 also includes an instantiation of an application agent 506 (e.g., the application agent 406, the agent module 306, etc.). The application agent 506 is here illustrated as interfacing with a user through a messaging interface 508. The messaging interface 508 includes a confirm button 510 and an edit button 512.

As outlined above, the application agent 506 includes application permissions (e.g., the permissions 410, the application permissions 218) of the application. By way of example, consider the application having permissions allowing access to a second application, which is a messaging application. The application may further have access to user location data and user location history. In this example, the user has been having a messaging conversation with two people, and over the course of the conversation they have decided to go out to dinner. The user invokes the application agent 506 within the application interface 500 and, as illustrated, requests a ride for dinner that night. The application agent 506, having access to the messaging data, determines that there are likely three total people going to dinner. Further, the application agent 506, having access to location data, determines that the user is at a house of the user. Further, the application agent 506, having access to the user location history, determines that the user frequents Coyne's Steakhouse. The application agent 506, using all of this information, responds to the user with “finding a ride to Coyne's Steakhouse for three people from your house.” In some examples, the application agent 506 may give the user the option to confirm that this action is in line with an intent of the user using the confirm button 510 or allow the user to edit the details of the action using the edit button 512.

In some examples, the application permissions are configurable by the user before their use by the application agent 506. For example, the user configures selected applications to have permission to access a feature of a device (e.g., a camera), user data, a wireless connection access, etc. In some examples, the application permissions are set when the application agent 506 requires access to features requiring permissions (e.g., the user data, another application data, etc.). In such examples, the application agent 506 may query the user to determine the application permissions. For example, the application agent 506 presents a message to the user asking for permission to access the features. In some examples, the response of the user is stored for future use such that the application agent 506 does not have to query the user in the future. In other examples, the application agent 506 queries the user each time the application agent 506 requires the application permissions.

In aspects, the determinations referenced in the above example (e.g., the determination that there are likely three total people going to dinner) are realized by the application agent 506 leveraging one or more LLMs (e.g., the LLM 304, the one or more LLMs 214, etc.). The one or more LLMs are able to parse an input in the form of natural language and derive intents and actions. For example, the one or more LLMs may take as an input the messaging data accessed by the application agent 506. The one or more LLMs contextualize the input and are able to find relevant correlations, for example allowing the one or more LLMs to derive that there are three people going to dinner.

In some examples, different members of the one or more LLMs are employed for different tasks. For example, a first LLM of the one or more LLMs is used to contextualize an input prompt while a second LLM of the one or more LLMs is used to generate a second input prompt. In another example, the first LLM is used to determine an intent of the input prompt while the second LLM is used to determine the action output. Further details of the workings of the one or more LLMs are detailed in the next section.

Further to the descriptions above, a user may be provided with controls allowing the user to make an election as to both if and when systems, programs, or features described herein may enable collection of user information (e.g., information about a user's social network, social actions, social activities, profession, preferences, or current location), and if the user is sent content or communications from a server. In addition, certain data may be treated in one or more ways before it is stored or used so that personally identifiable information is removed. For example, a user's identity may be treated so that no personally identifiable information can be determined for the user, or a user's geographic location may be generalized where location information is obtained (for example, to a city, ZIP code, or state level) so that a particular location of a user cannot be determined. Thus, the user may have control over what information is collected about the user, how that information is used, and what information is provided to the user.

### Large Language Models (LLMs)

Generally, large language models (LLMs) are a class of artificial intelligence (AI). LLMs (e.g., the LLM 214, the LLM 304) are trained on enormous amounts of data to provide foundational capabilities, which can be used and reused, often through fine-tuning for particular applications and tasks. Other software applications, in contrast, are often built and trained in a specific domain for each use case. In this way, LLMs are considered a type of foundational model.

Some LLMs use a machine-learned (ML) computer model that is able to parse language and provide context-aware outputs, such as to mimic a human response. This mimic of a human response is typically to a prompt, such as from a user asking a question. The prompt “ask how to get to the train station in French,” for example, can be used as a prompt by which an LLM provides a translation service, namely a human response in French to the English prompt. In the example of the ride-sharing application interface 500 of FIG. 5, the prompt may be “find me a ride for dinner tonight.”

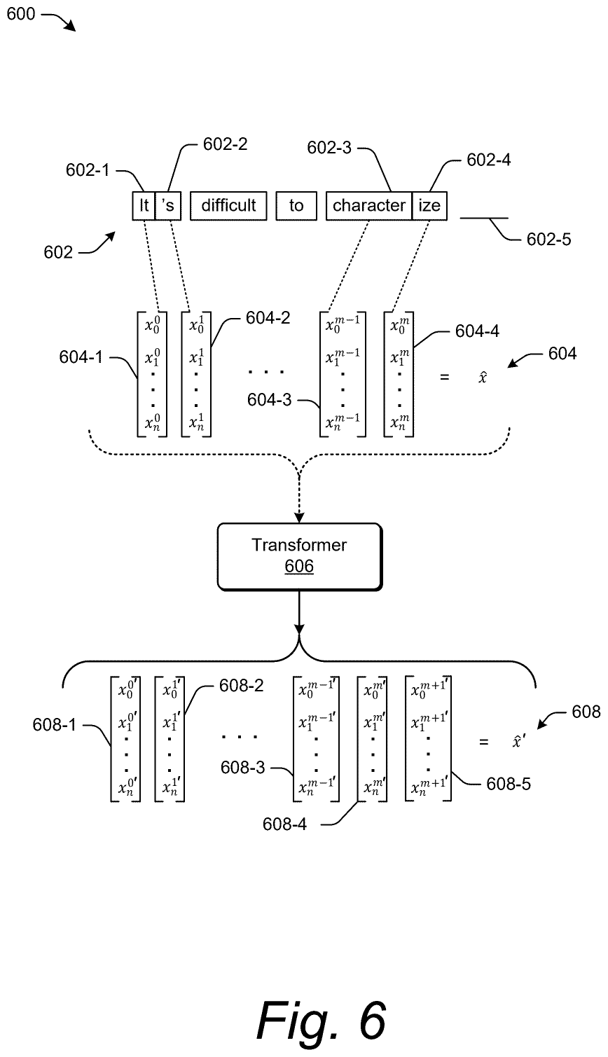

By way of example, consider FIG. 6, which illustrates a trainer 600 by which to train an LLM used for exposing application functionality using system-level LLM agent services. The trainer 600 receives training data as training inputs, such as an input 602. This training data may be of many different types, such as user queries to one or more application agents (e.g., the application agent 406, the application agent 506, the agent module 306, etc.). In the example illustrated by FIG. 6, the training input 602 is a phrase, though it may instead be a word, a long text passage (e.g., a book, article, or web-page), or any other data containing comprehensible text. In a process called “tokenization,” the trainer 600 breaks the training input 602 into tokens, marked as tokens 602-1, 602-2, 602-3, and 602-4. Here the training input 602 has a missing next word, marked as a blank 602-5. The goal of the trainer 600 is to predict the blank 602-5.

The trainer 600 encodes the tokens (602-1, 602-2, etc.) into an input tensor \hat{x} 604 through a mapping procedure. For instance, the token “It” 602-1 is mapped to a first component 604-1 of the input tensor \hat{x} 604, the token “'s” is mapped to a second component 604-2 of the input tensor \hat{x} 604, the token “character” is mapped to a third component 604-3 of the input tensor \hat{x} 604, and the token “ize” is mapped to a fourth component 604-4 of the input tensor \hat{x} 604. Though the tokens “It” 604-1 and “'s” 604-2 are shown as two portions of the word “It's,” other mapping schemes exist, such as mapping based on discrete words or phonemes. In some instances, an ML model or an ML component of the trainer 600 performs the tokenization and/or mapping of the training input 602 into the input tensor \hat{x} 604 (e.g., a feature-extracting convolutional neural network (CNN)). The mapping of the tokenized training input 602 into the input tensor \hat{x} 604 may involve a lookup table, which maps each possible token (e.g., 602-1, 602-2, etc.) to a known tensor object in a language space of the training data.

A transformer 606 takes the input tensor \hat{x} 604 as an input, with the goal of predicting the blank 602-5 by transforming the input tensor \hat{x} 604 into a transformed tensor \hat{x}′ 608.

The transformation process is mathematically represented as follows:

$$T \hat{x} = {\hat{x}}^{′} \qquad Eq . 1$$

T in Eq. 1 represents the transformer 606. The transformed tensor \hat{x}′ 608 includes components 608-1, 608-2, 608-3, 608-4, and 608-5. The component 608-1 is a transformation of the component 604-1 by the transformer 606 (similar for component pairs 608-2/604-2, 608-3/604-3, and 608-4/604-4). The component 608-5 corresponds to the blank 602-5, and thus the component 608-5 is a prediction for the blank 602-5. The final transformed tensor \hat{x}′ 608 component 608-5 is derived as part of the transformation process in addition to the contextualization of the components 604-1 through 604-4.

Inputs such as the input tensor \hat{x} 604 and/or the training input 602 generally include multiple tokens. For instance, the training input 602 includes the tokens 602-1 through 602-4. The trainer 600 converts a single training input (e.g., the training input 602) into multiple training inputs. For example, by removing the token 602-4, the blank 602-5 “shifts left” as the training input 602 calls for the trainer 600 to predict the token 602-4, thus creating a new training input from the original training input 602. As the value for the token 602-4 is known in this example, the new input is a labeled input, which allows it to be used by a supervised ML training algorithm (it should be noted that such an input is also able to be used by an unsupervised ML training algorithm). In this way, a single text containing multiple tokens (e.g., a book, a research paper, etc.) is used as multiple training inputs for the trainer 600.

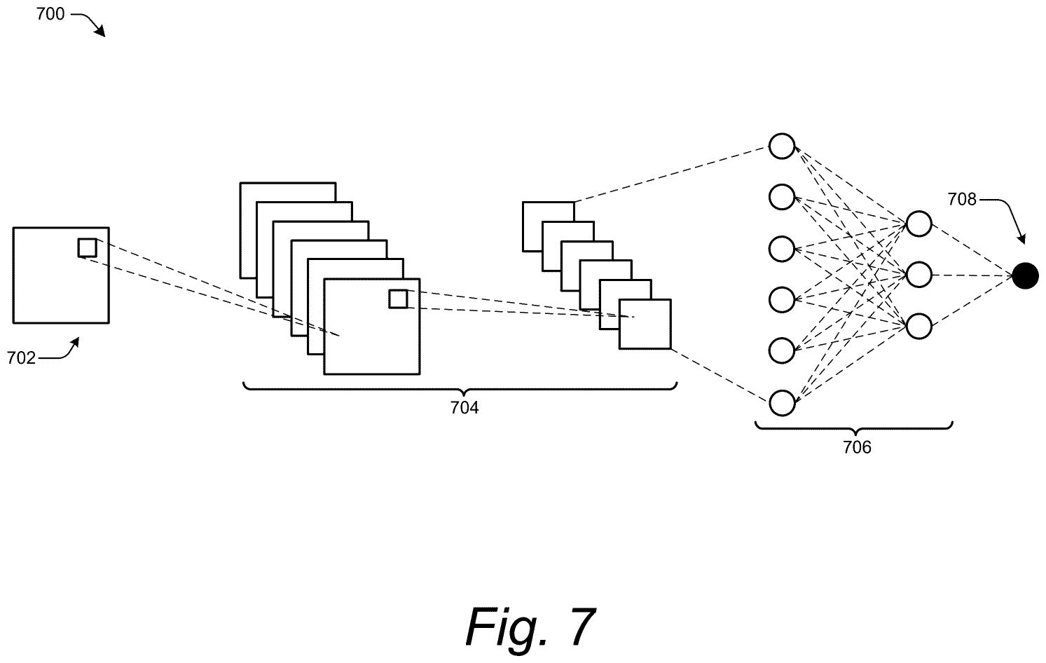

An example transformer 700 is shown in FIG. 7. The transformer 700 is used to both contextualize words within an input prompt and to predict a next word from the input prompt. The transformer 700 includes an attention 702, a multi-head attention 704, a multi-layer perceptron (MLP) 706, and an output 708. The attention 702 and the multi-head attention 704 take tokenized and mapped inputs (e.g., the input tensor \hat{x} 604 of FIG. 6) and contextualize them, similarly to how a speaker of a language will understand the meaning of a word in the context of the rest of the words in a sentence in which the word is found. The contextualization employs known correlation operators, such as matrix operators, normalization, dot product operators, etc. to characterize correlations in components (e.g., the components 604-1, 604-2, etc. of FIG. 6) of an input tensor (e.g., the input tensor \hat{x} 604 of FIG. 6). The output 708 is a prediction based on a transformation of the input tensor (e.g., the component 608-5 of the transformed tensor \hat{x}′ 608 of FIG. 6). For example, in the ride-sharing application given in FIG. 5, the prediction may include the number of participants going to dinner, the restaurant, the user location, etc.

In some examples, the transformer 700 also includes ML components, such as the MLP 706. The MLP 706 is used to derive additional correlations in the input tensor (e.g., the input tensor \hat{x} 604 of FIG. 6) apart from the contextualization done by the attention 702 and/or the multi-head attention 704. Although a single MLP 706 is pictured as a final step of the transformer 700 before the output 708, this need not be the case. Multiple MLPs may be included, the components may be connected in a different order (e.g., an additional MLP in between the attention 702 and theti-head attention 704, a CNN prior to the attention 702, etc.), or other components not listed may also be included. Components of the transformer 700 may run in series, in parallel, or in a combination of both series and parallel operations. Additionally or alternately, the transformer 700 may have a different makeup of attention components. There may be multiple or no single attentions (e.g., the attention 702), multiple or no multi-head attentions (e.g., the multi-head attention 704), or any combination of attentions and multi-head attentions. In general, the transformer 700 is not limited to the specific makeup shown in FIG. 7 and may have different components than those pictured.

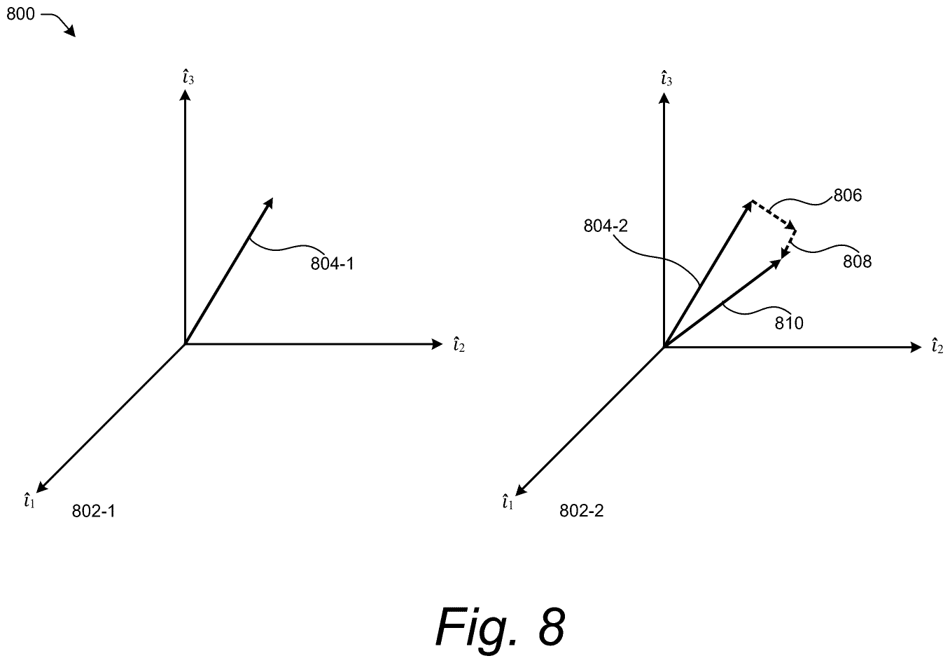

FIG. 8 illustrates an example transformation 800 in a language space 802-1 of an input tensor component 804-1 (e.g., the component 604-1 of the input tensor \hat{x} 604 of FIG. 6). The language space 802-1 is a multi-dimensional mathematical space, which includes specific language components codified as tensors within the multi-dimensional mathematical space. The term “tensor” is a mathematical object of any dimensionality, including scalar, vector, and matrix quantities. The language space 802-1 is therefore a mathematical vocabulary, and mapped tokens (e.g., token 602-1 of FIG. 6) are tokens that have been translated into the mathematical vocabulary. For ease of illustration, the language space 802-1 is shown in FIG. 8 as a three-dimensional space with orthogonal basis vectors \hat{l}₁, \hat{l}₂, and \hat{l}₃. However, this should not be seen as limiting. In general, the language space 802-1 has the dimensionality of the mapped tokens from an input tensor. For example, the input tensor \hat{x} 604 of FIG. 6, whose tensor components 604-1 through 604-4 each contain n members, corresponds to an n-dimensional language space.

The input tensor component 804-1 is plotted in the language space 802-1, shown in FIG. 8 as a vector in three-dimensional space. In some examples, the plotting is the product of a lookup table, a CNN feature mapping, or any other mapping from the token into the language space 802-1. The input tensor component 804-1 is transformed by the transformation 800. Consider a language space 802-2, identical to the language space 802-1, and an input tensor component 804-2, identical to the input tensor component 804-1. The transformation 800 is based on transformation operators 806 and 808 and performed by a transformer (e.g., the transformer 700 of FIG. 7). The transformation operators 806 and 808 are illustrated as vector addition operators, resulting in a remapped tensor 810.

As an illustration of this transformation, let the input tensor component 804-2 represent a mapped (i.e., translated into the mathematical vocabulary of the language space 802-2) token of “rodent” and let the transformation operators 806 and 808 be generated by contextualizing mapped tokens “large” and “eared” from an input prompt, which includes the phrase “large-eared rodent.” Contextualizing is defined as characterizing the correlations between “rodent,” “large,” and “eared” from the input prompt (e.g., the input 602 of FIG. 6) in a way that corresponds with how a speaker of the input prompt's language would understand the word “rodent” as it appears in the input prompt along with “large” and “eared.” In this illustration, the transformed tensor 810 maps to an area of the language space 802-2 containing the word “chinchilla.”

Though the transformation of the input tensor component 804-2 to the transformed tensor 810 has been shown as two transformations using the transformation operators 806 and 808, this should not be seen as limiting. Any number of transformation operations may be employed, including more than two or a single transformation operation. Transformation operators (e.g., the transformation operator 806) may also take forms other than vector/tensor addition, such as multiplication (e.g., scaling, matrix multiplication, dot product, cross product, tensor product, etc.), normalization, orthogonalization, or any combination of these or other transformation operations known to a person of ordinary skill in the art. Thus, the transformation operators 806 and 808 of FIG. 8 are meant to be illustrative, not limiting.

Sophisticated LLMs may have a very large number of trained parameters, with modern LLMs boasting hundreds of billions of parameters in their employed models. Because of this, it is often advantageous not to train an LLM from scratch but rather to fine-tune an already-trained model. To give a human analogy, this is much like teaching a person who already knows a language how to write in the American Psychological Association (“APA”) style. It takes an entire upbringing for the person to master the language, but a single university course suffices to learn the APA writing style.

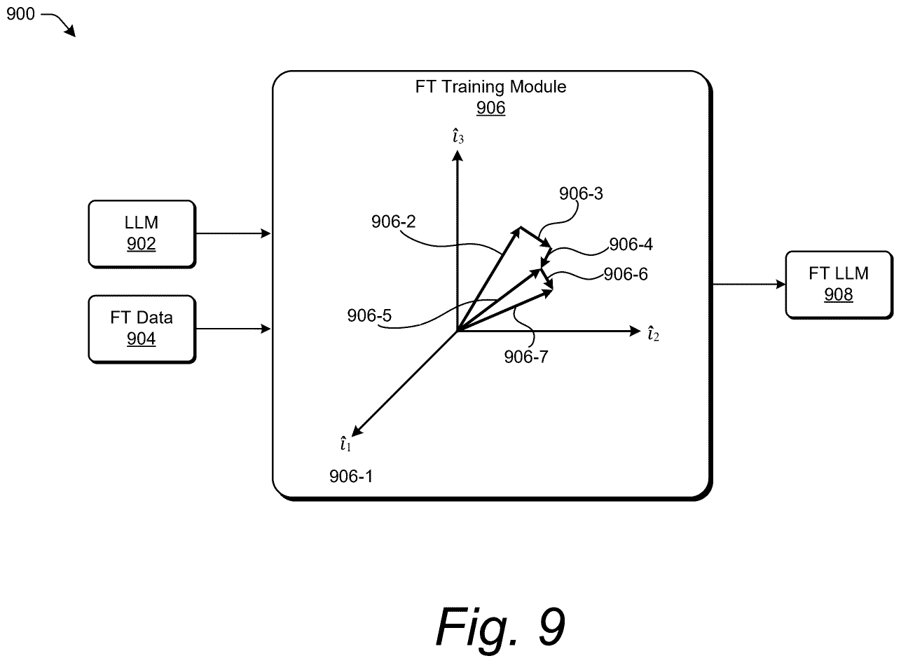

By way of example, consider FIG. 9, which illustrates a fine-tuning (FT) trainer 900. The FT trainer 900 takes an LLM 902 (e.g., an LLM previously trained by the trainer 600) and FT data 904 as training inputs. For example, the FT data 904 may be the user data 412, the user data 224, other data from the one or more applications 222, etc. The FT trainer 900 includes an FT training module 906 and a final output in the form of an FT LLM 908.

The FT training module 906 includes a language space 906-1. Though the language space 906-1 has here been illustrated as a three-dimensional space with orthogonal basis axes \hat{l}₁, \hat{l}₂, and \hat{l}₃, this should not be seen as limiting. In general, the language space 906-1 may have the dimensionality of its input data, such as an input tensor 906-2. The language space 906-1, in some examples, may be of a lower dimension than a language space used to train the LLM 902 (e.g., the language space 802-1 of FIG. 8). The input tensor 906-2 (e.g., the component 604-2 of FIG. 6) is mapped into the language space 906-1 and transformed by transformation operators 906-3 and 906-4. The transformation performed by the transformation operators 906-3 and 906-4 is by way of the LLM 902, giving a resultant transformed tensor 906-5 (e.g., similar to the remapped tensor 810 resulting from the transformation 800 of FIG. 8). In some examples (not pictured), the transformation process may include a change of basis into another language space or a mapping into a smaller language space.

The FT training module 906 includes an additional transformation operator 906-6, resulting in a final tensor 906-7. This may be represented mathematically as follows:

$$F ( T \hat{x} ) = {\hat{x}}^{′} + δ x \qquad Eq . 2$$

T, as in Eq. 1, is the transformation performed by the LLM 902 (e.g., an LLM trained by the trainer 600 of FIG. 6), F is the additional transformation operator 906-6, \hat{x}′ is the transformed tensor 906-5 (e.g., the remapped tensor 810 of FIGS. 8), and δx is a perturbation component. The perturbation component 8x is shown in the language space 906-1 as the additional transformation operator 906-6, giving the final tensor 906-7. The perturbation component δx is based on the FT data 904. The final tensor 906-7 is the mapped representation of \hat{x}′+δx. This gives the FT LLM 908 all of the capabilities of the LLM 902 with the additional context of the FT data 904.

Consider, as before, an example of the input tensor 906-2 representing a mapping of a token “rodent” into the language space 906-1, the transformation operator 906-3 representing a mapping of a token “large” into the language space 906-1, and the transformation operator 906-4 representing a mapping of a token “eared” into the language space 906-1. The transformed tensor 906-5 represents a region of the language space 906-1 containing “chinchilla.”

By way of example, suppose a veterinarian office wishes to fine-tune (FT) train the LLM 902 to associate types of medications with animal types. Training the entire LLM 902 is logistically prohibitive, and a different LLM containing the correlation between the types of medication and the animal types may be unavailable. Instead, the veterinarian office employs the FT trainer 900, where the FT data 904 includes the correlations between the types of medication and the animal types. The additional transformation operator 906-6 associates a chinchilla with a specific type of medication. Thus, the final tensor 906-7 contains the type of medication corresponding with, for example, rodents, which is not found in the LLM 902.

While the FT training module 906 has been shown as performing the additional transformation operator 906-6 as a single operation, this need not be the case. The additional transformation operation 906-6 may include several operations, a change in dimensionality, or any other of a number of transformations known to a person of ordinary skill in the art. Further, the FT training module 906 may include other components not pictured, such as MLP or CNN components, additional feature mapping, etc. The illustration of a single operation for the additional transformation operator 906-6 is shown for brevity and to aid in understanding, not to express a limitation on the functionality of the FT training module 906.

In some instances, it is desirable to guide the output of an LLM without fine-tuning the LLM. For example, a programmer may wish to add the functionality of an already-trained LLM to an application via an Application Programming Interface (API) call, including all of the up-to-date functionality of the LLM with no additional training or upkeep needed from the programmer. In such instances, the only avenue to guide the output of the LLM is the input prompt. Tailoring the input prompt to obtain a desired output is known as prompt engineering.

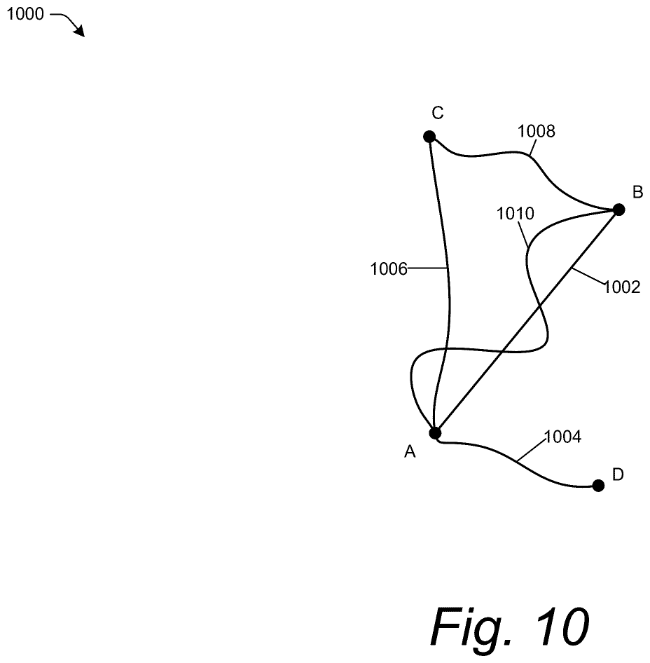

By way of example, consider FIG. 10, which illustrates a prompt engineering 1000. An entry prompt A is an attempt to obtain a desired result B using an LLM (e.g., the LLM 902 of FIG. 9). The LLM includes different computational avenues leading to results (“paths”) based on a form of the entry prompt A. There may exist, at least in concept, an ideal path 1002 leading from the entry prompt A to the desired result B in the most efficient manner possible. There are also other paths, such as a false path 1004 leading to an undesired result D, an intermediate path 1006 leading to an intermediary result C, another intermediate path 1008 leading from the intermediate result C to the desired result B, and an inefficient path 1010 leading from the entry prompt A to the desired result B. Many paths may exist, limited only by a scope of the LLM and a scope of the entry prompt A. The ideal path may be expressed mathematically as follows:

$$S = \int ℒ ( φ , θ ( φ ) , … ) d φ \qquad Eq . 3$$

S in Eq. 3 represents the ideal path 1002 and [symbol] represents the entry prompt A, which is characterized by a language space φ (e.g., the language space 802-1 of FIG. 8) and a function θ(φ) for the path propagation in the language space φ. It may be difficult to distinguish the various paths 1004-1010 from the ideal path 1002. In order to reach or reasonably approximate the ideal path 1002, variations are made to the entry prompt [symbol] as follows:

$$\hat{S} = \int ℒ ( φ , θ ( φ ) + εη ( φ ) ) d φ \qquad Eq . 4$$

Ŝ in Eq. 4 represents a path, which deviates from the ideal path 1002 (S) by the function η(φ), where η(ε) is characterized by the parameter ε. During the prompt engineering 1000, various iterations of the entry prompt A are input into the LLM in an attempt to find an acceptable path. By way of example, a form of the entry prompt A does not reach the desired result B (e.g., the false path 1004) and is discarded. In another example, another form of the entry prompt A gives the intermediate path 1006, arriving at the intermediate result C, and a subsequent prompt gives the intermediate path 1008 from the intermediate result C to the desired result B. Though this reaches the desired result B, multiple steps are taken, which is less efficient than a single, direct prompt. In another example, another form of the entry prompt A gives the inefficient path 1010, which arrives at the desired result B. In another example, another form of the entry prompt A gives the ideal path 1002 (or an acceptable approximation) to the desired result B. Characterization of variations in the form of the entry prompt A may be expressed mathematically as follows:

$$\frac{\partial \hat{S}}{\partial ε} \leq ψ \qquad Eq . 5$$

Eq. 5 illustrates the variation of a deviation

$$\frac{\partial \hat{S}}{\partial ε}$$

of the path Ŝ by the parameter ε, with ψ being a maximum acceptable value. In an ideal scenario, for instance, ψ=0. Consider the example of FIG. 5, where the user requests the application agent 506 find the user a ride to dinner. The application agent 506 may access the LLM and leverage the prompt engineering 1000, having been trained with various forms of the input prompt A. By way of example, consider the prompt A having the form, as in FIG. 5, of “find me a ride for dinner tonight.” Suppose the LLM finds the closest local restaurant to the user and finds a ride through the ride-sharing application functionality with the cheapest rate, such as with a small vehicle. In this example, the user may not prefer the closest local restaurant, the small vehicle may not accommodate all of the potential passengers, or the LLM output may otherwise not be in line with the intent of the user in their entry of the prompt A. This example output from the LLM is represented by the undesired result D, which is not an acceptable path for the prompt engineering 1000.

Consider another example of the above form of the prompt A, but now suppose there is a follow-up step in a training of the application agent 506 by automatically entering another prompt of the form “pick a restaurant from among my favorite places to eat, and include everyone in my recent messaging conversation,” resulting in the LLM selecting Coyne's Steakhouse and finding a vehicle that comfortably accommodates three people. With the initial closest restaurant and the small vehicle found represented by the intermediate result C, the resultant recommendation of Coyne's Steakhouse and the larger vehicle is represented by the desired result B. This process is represented by the additive paths 1006+1008. Though the desired result B is reached, it is possible that the deviation

$$\frac{\partial ε}{}$$

is still above the maximum acceptable value ψ, which may be due to a computation cost, an inability to enter multiple prompts, or other limitations.

Consider an example of the entry prompt A for an application agent (e.g., the application agent 406) instantiated within a social media application, with the entry prompt A having the form “post this image to my feed.” Further consider the application agent 406 parsing the entry prompt A, through training via prompt engineering, to have an updated form of “post this image to my feed and filter it to match styles I typically use” (in aspects, the updated entry prompt may be based on a knowledge of unsuccessful forms of the entry prompt A, forms of the entry prompt A used in prompt engineering in a training phase of the application agent, etc.). By way of example, the LLM returns an executable code for use in the social media application, which applies five filters to a user image resulting in a substantial match to filtration used most commonly by the user in similar posted images. The deviation

$$\frac{\partial ε}{}$$

may again exceed the maximum acceptable value ψ. This is illustrated by the inefficient path 1010. In a similar example, suppose the entry prompt A is reformatted by the application agent to the form “match this image to similar images in my feed, filter it with the most common filter used on those similar images, and post it to my feed.” The result may be a single filtering, using the user's most commonly used filter for this sort of image, which results in the deviation

$$\frac{\partial \hat{S}}{\partial ε}$$

value falling at or under the maximum acceptable value ψ, which is represented by the ideal path 1002.

Each of the forms of the entry prompt A in the previous several examples may be used to train the application agent to parse the entry prompt A in order to reformat it in a way that is in line with an intent of the entry prompt A. The prompt engineering 1000 leverages the failed paths from all of the forms of the entry prompt A to arrive at an acceptably efficient and succinct prompt, which results in the desired result B. In some examples, the parsing of the entry prompt A in order to determine the intent may be done by the LLM. The LLM may also be used in the prompt engineering 1000 to generate additional forms of the entry prompt A, to find follow-up prompts, to classify intents, or to perform other aspects of the prompt engineering 1000.

### Example Methods

The method 1100 is shown as a set of blocks that specify operations performed but are not necessarily limited to the order or combinations shown for performing the operations by the respective blocks. Further, any of one or more of the operations may be repeated, combined, reorganized, or linked to provide a wide array of additional and/or alternate methods. In portions of the following discussion, reference may be made to any of the preceding figures or processes as detailed in other figures, reference to which is made for example only. The techniques are not limited to performance by one entity or multiple entities operating on one device.

Generally, any of the components, modules, methods, and operations described herein can be implemented using software, firmware, hardware (e.g., fixed logic circuitry), manual processing, or any combination thereof. Some operations of the example methods may be described in the general context of computer program products, such as executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, field-programmable gate arrays (FPGAs), application-specific integrated circuits (ASICs), application-specific standard products (ASSPs), system-on-a-chip systems (SoCs), complex programmable logic devices (CPLDs), and the like.

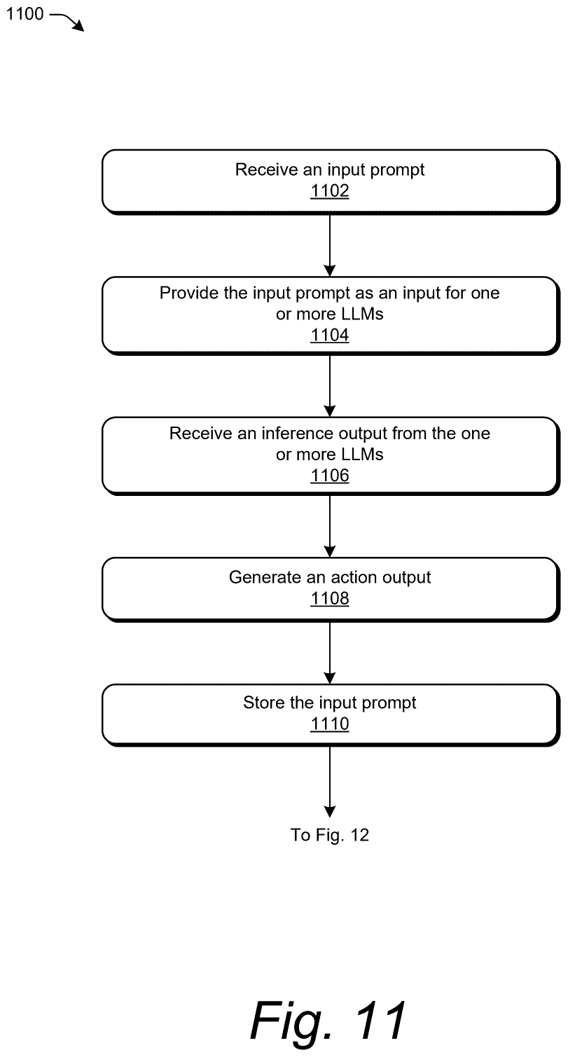

FIG. 11 illustrates an example method 1100 for exposing application functionality using system-level LLM agent services in accordance with one or more implementations. At 1102, an input prompt is received, the input prompt comprising a plurality of words in a natural-language format. The input prompt may be a user-generated input prompt. The input prompt may be, at least in part, generated by one or more LLMs (e.g., the one or more LLMs 214, the LLM 304, etc.), which, in some examples, may be stored in a memory of a device (e.g., the device 202) executing the method 1100 or of another device. The input prompt may be a user-selected input prompt from a plurality of input prompts, where the plurality of input prompts may be the product of prompt engineering (e.g., the prompt engineering 1000), user-generated input prompts, or a combination of both. The prompt engineering may include generation of an optimized input prompt based on receiving, by the one or more LLMs, a plurality of training input prompts, generating, by the one or more LLMs, a plurality of training action outputs, each of the plurality of training action outputs associated with a corresponding one of the plurality of training input prompts, comparing each of the plurality of training action outputs with a threshold value, and selecting, based on the comparison of each of the plurality of training action outputs with the threshold value, one of the plurality of training input prompts as the optimized input prompt. The input prompt, in some examples, may be generated by one or more applications accessible to the device.

At 1104, the input prompt is provided as an input for the one or more LLMs. At 1106, an inference output is received from the one or more LLMs. The inference output is based on the input prompt and indicative of an intent of the input prompt.

At 1108, an action output is generated. The action output is based on the determined intent of the input prompt. The device is configured to perform the action output. The action output, in some examples, may be further based on one or more components of the device, one or more functions of an operating system stored in the memory of the device, or one or more functions of a second device in communication with the device over a network or other connection. The device, in some examples, may be configured to perform the action output by using a functionality of one or more applications accessible to the device. The generation of the action output, in some examples, may be limited by a permission of one or more applications, the permission comprising a list of one or more resources of the device and/or one or more user data. The action output may be configured such that it cannot access a device functionality related to the list of the one or more resources of the device and/or the one or more user data.

In some examples, the action output comprises one or more executable instructions for the device. The one or more executable instructions (e.g., executable code), in some examples, may be configured to cause one or more processors to perform the one or more executable instructions in sequence, with at least one of the one or more executable instructions dependent on at least one other of the one or more executable instructions. In some examples, the one or more executable instructions are configured to be executed using a plurality of applications available to the one or more processors, and the one or more executable instructions include a first instruction for execution using a first application of the plurality of applications available to the one or more processors and a second instruction for execution using a second application of the plurality of applications available to the one or more processors.

At 1110, the input prompt is stored. In some examples, the storage of the input prompt may be in the memory of the device. In some examples, the input prompt may be stored outside of the device. Storage outside of the device may include a memory of another device or a cloud storage. The stored input prompt, in some examples, is configured to be categorized by a type of input for the input prompt. In some examples, the stored input prompt is configured to be used as a future input for the one or more LLMs. In some examples, the storing of the input prompt is based on a comparison of the action output to the input prompt.

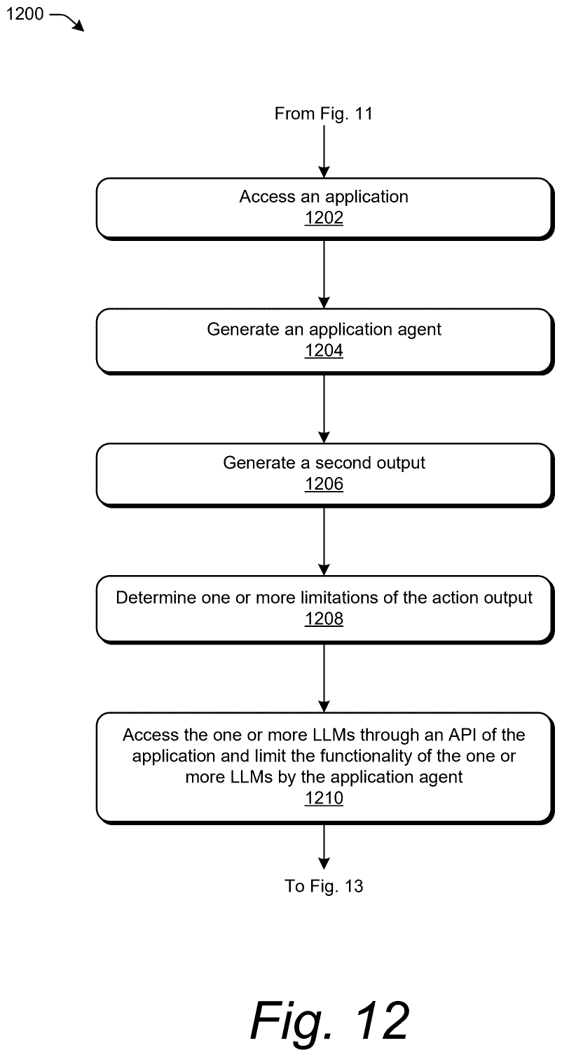

FIG. 12 illustrates an example method 1200 for exposing application functionality using system-level LLM agent services in accordance with one or more implementations. The method 1200 employs the method 1100. At 1202, an application is accessed. The application, in some examples, may be stored on a memory of the device. In other examples, the application may be stored remotely from the device, such as on a cloud-based server. The accessing of the application, in some examples, includes accessing a plurality of applications.

At 1204, an application agent is generated. The application agent may be instantiated within the application, such as in an application interface. The generating of the application agent, in aspects, may be the instantiation of the application agent. The receiving of the input prompt may be performed by the application agent. In some examples, the generation of the application agent includes generating a plurality of application agents, each of the plurality of application agents associated with a corresponding one of a plurality of applications. In some examples, the action output is further based on one or more available functions or limitations of the plurality of applications, such as the available functions of at least two of the plurality of applications. In some examples, the action output is generated based at least in part on a functionality of a second application, the second application being a different application than the application in which the application agent is instantiated. In some examples, the input prompt is generated by the application agent.

At 1206, a second output is generated. The second output is based on the action output and is configured to be output to a user through the application agent. The second output may be based on a user intent, the user intent determined by the application agent. An example of the second output is a message to the user to confirm that the action output is the user intent. In some examples, the determination of the user intent is based at least in part on a previous interaction of the user with the application agent.

At 1208, one or more limitations of the action output are determined. The one or more limitations are based on a plurality of available functions of the application and/or a permission set of the application, the permission set comprising a list of allowed and/or restricted resources of the device for access by the application. In some examples, the one or more limitations are further based on a plurality of available functions of an outside application and a permission set of the outside application comprising a list of allowed and/or restricted resources of the device for access by the outside application.

At 1210, the one or more LLMs are accessed through an API of the application and the functionality of the one or more LLMs is limited by the application agent. The limiting of the functionality of the one or more LLMs is based on one or more permissions of the application. For example, if the application is a messaging application and does not have permission to access a camera of the device, the one or more LLMs are limited by the application agent to exclude any action output that includes camera functionality.

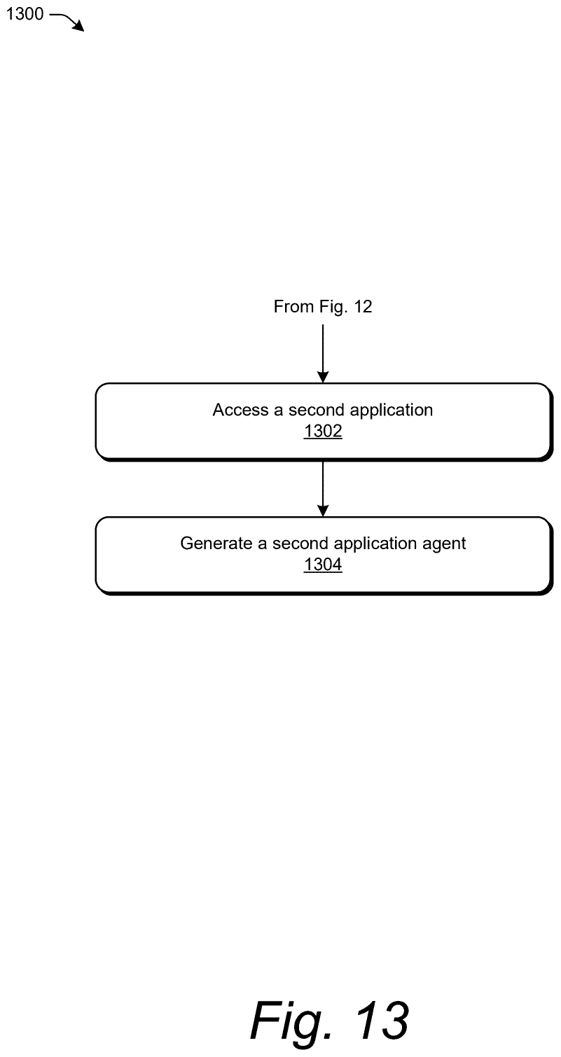

FIG. 13 illustrates an example method 1300 for exposing application functionality using system-level LLM agent services in accordance with one or more implementations. The method 1300 employs the method 1200. At 1302, a second application is accessed. The second application, in some examples, is stored on a memory of the device. In other examples, the second application is stored remotely from the device, such as on a cloud-based server. The accessing of the second application, in some examples, includes accessing a plurality of applications.

At 1304, a second application agent is generated. The second application agent is instantiated within the second application, such as in a second application interface. The generating of the second application agent, in aspects, may be the instantiation of the second application agent. The second application interface, in some examples, includes an instantiation of the application agent. The receiving of the input prompt, in some examples, is performed by the second application agent. In some examples, the generation of the second application agent includes generating a plurality of application agents, each of the plurality of application agents associated with a corresponding one of a plurality of applications. In this example, the action output is further based on one or more available functions or limitations of the plurality of applications, such as the available functions of at least two of the plurality of applications. In some examples, the input prompt is generated by the second application agent.

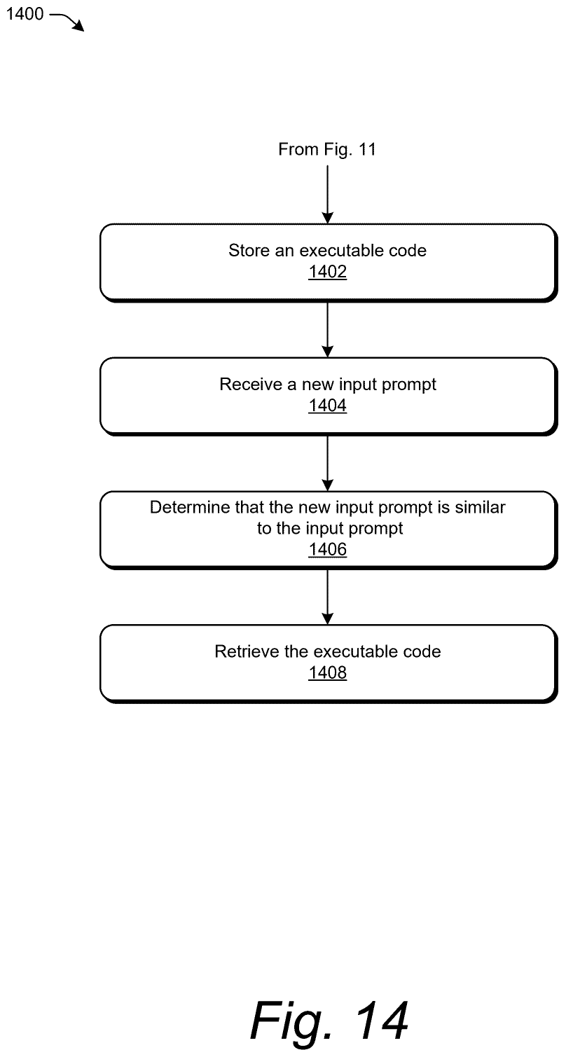

FIG. 14 illustrates an example method 1400 for exposing application functionality using system-level LLM agent services in accordance with one or more implementations. The method 1400 employs the method 1100. The generation of the action output in the method 1400 includes an executable code. The executable code may be generated, at least in part, by the one or more LLMs. At 1402, the executable code is stored.

At 1404, a new input prompt is received. For example, a user submits a home-automation routine as the input prompt. For example, the input prompt is of the form “don't run the sprinklers when rain is forecast.” The action output associated with such an input prompt is, for example, an executable code used for entry with a wireless sprinkler system. The new input prompt is, for example, of the form “adjust my sprinklers for weather conditions.”

At 1406, the new input prompt is determined to be similar to the input prompt. Using the above sprinkler example, the new input prompt and the input prompt are input into the one or more LLMs. The one or more LLMs generate a comparison value based on determined similarities between the input prompt and the new input prompt, such as by contextualizing, transforming, or other techniques employed by the one or more LLMs.

At 1408, the executable code is retrieved. For example, if the executable code is stored in a memory of the device, the executable code is entered as data in an application. In some examples, the executable code is then executed. Using the above sprinkler example, the new input prompt and the input prompt are determined to be similar enough that the executable code associated with the input prompt is used as the action output for the new input prompt. Based on the intent of the input prompt, the device may be caused to perform the action output.

### Additional Examples

Various examples are described herein, including a first example method (example 1) that includes receiving, by one or more processors, an input prompt, the input prompt comprising a plurality of words in a natural-language format, providing, by the one or more processors, the input prompt as an input for one or more LLMs, receiving, by the one or more processors, an inference output of the one or more LLMs, the inference output based on the input prompt and indicative of an intent of the input prompt, and causing, by the one or more processors and based on the determined intent of the input prompt, an action output, a device to perform an action output.

Example 2: The method of example 1, wherein the input prompt is a user-generated input prompt.

Example 3: The method of example 1, wherein the input prompt is generated at least in part by the one or more LLMs.

Example 4: The method of example 1, wherein the input prompt is a user-selected input prompt from a plurality of available input prompts.

Example 5: The method of example 4, wherein the plurality of available input prompts are the product of previous prompt engineering.

Example 6: The method of example 4, wherein at least one of the plurality of available input prompts is a user-generated input prompt.

Example 7: The method of any one of the previous examples, further comprising accessing, by the one or more processors, an application, and generating, by the one or more processors and based on one or more parameters of the application, an application agent, wherein the application agent is instantiated within the application, the instantiation comprising an interface within the application, and the receiving of the input prompt is performed by the application agent.

Example 8: The method of example 7, wherein the action output comprises at least one functionality of at least one outside application, the outside application being different than the application in which the application agent is instantiated.

Example 9: The method of example 7, further comprising generating, by the one or more processors, a second output, the second output based on the action output and configured to be output to a user through the application agent.

Example 10: The method of example 7, further comprising accessing, by the one or more processors, a second application, and generating, by the one or more processors and based on one or more parameters of the second application, a second application agent, wherein the second application agent is instantiated within the second application, the instantiation comprising an interface within the second application, and the interface within the second application includes the application agent.

Example 11: The method of example 7, wherein the accessing of the application comprises accessing a plurality of applications, and the generation of the application agent comprises generating a plurality of applications agents, each of the plurality of application agents associated with a corresponding one of the plurality of applications.

Example 12: The method of example 11, wherein the action output is further based on one or more of available functions or limitations of the plurality of applications.

Example 13: The method of example 12, wherein the action output is further based on the available functions of at least two of the plurality of applications.

Example 14: The method of example 7, further comprising determining, by the application agent, one or more limitations of the action output, the one or more limitations based on a plurality of available functions of the application, and a permission set of the application comprising a list of allowed resources of the device available for access by the application.

Example 15: The method of example 14, wherein the one or more limitations are further based on a plurality of available functions of an outside application, and a permission set of the outside application comprising a list of allowed resources of the device available for access by the outside application.

Example 16: The method of example 7, further comprising accessing, by the application agent, the one or more LLMs through an application programming interface (API) of the application, and limiting, by the application agent, the functionality of the one or more LLMs based on one or more permissions of the application.

Example 17: The method of any one of the previous examples, wherein the input prompt is a product of prompt engineering, the prompt engineering comprising generation of an optimized input prompt based on receiving, by the one or more LLMs, a plurality of training input prompts, generating, by the one or more LLMs, a plurality of training action outputs, each of the plurality of training action outputs associated with a corresponding one of the plurality of training input prompts, comparing each of the plurality of training action outputs with a threshold value, and selecting, based on the comparison of each of the plurality of training action outputs with the threshold value, one of the plurality of training input prompts as the optimized input prompt.

Example 18: The method of any one of the previous examples, wherein at least one of the one or more LLMs is stored in a memory of the device.

Example 19: The method of any one of examples 1-17, wherein at least one of the one or more LLMs is stored in a memory of a second device, the second device being different from the device.

Example 20: The method of any one of examples 1-18, wherein the action output is further based on one or more of one or more components of the device, one or more functions of an operating system stored in a memory of the device, or one or more functions of a second device, the second device in communication with the device over a network connection.

Example 21: The method of any one of the previous examples, further comprising storing, by the one or more processors, the input prompt, wherein the stored input prompt is configured to be used as a future input for the one or more LLMs.

Example 22: The method of example 21, wherein the storing of the input prompt is based on a comparison of the action output to the input prompt.

Example 23: The method of example 1, wherein the action output is further configured to cause the device to perform the action output by using a functionality of one or more applications accessible to the device.

Example 24: The method of example 23, wherein the generation of the action output is limited by a permission of the one or more applications, the permission comprising a list of one or more resources of the device, the action output configured such that it cannot access a device functionality related to the list of the one or more resources of the device.

Example 25: The method of example 23, wherein the generation of the action output is limited by a permission of the one or more applications, the permission comprising a list of one or more user data, the action output configured such that it cannot access the one or more user data.

Example 26: The method of any one of the previous examples, wherein the generating of the action output is performed at least in part by the one or more LLMs.

Example 27: The method of example 26, wherein the generating of the action output at least in part by the one or more LLMs comprises generating, by the one or more LLMs and based on the input prompt, an executable code.

Example 28: The method of example 27, further comprising storing, by the one or more processors, the executable code.

Example 29: The method of example 28, further comprising receiving, by the one or more processors, a new input prompt, determining, by the one or more processors, that the new input prompt is similar to the input prompt, retrieving, by the one or more processors, the executable code, and executing, by the one or more processors, the executable code.

Example 30: The method of example 29, wherein the determining that the new input prompt is similar to the input prompt comprises generating, using the one or more LLMs, a comparison value of the new input prompt to the input prompt, and comparing the comparison value to a prompt threshold value.

Example 31: The method of example 1, wherein the input prompt is generated by an application accessible to the device.

Example 32: The method of example 7, wherein the input prompt is generated by the application agent.

Example 33: The method of example 32, further comprising determining, by the application agent, a user intent, wherein the input prompt is based on the user intent.

Example 34: The method of example 33, wherein the determination of the user intent is based at least in part on a previous interaction of the user with the application agent.

Example 35: The method of example 10, wherein the input prompt is generated by the application agent.

Example 36: The method of example 35, further comprising determining, by the application agent, a user intent, wherein the input prompt is based on the user intent.

Example 37: The method of example 36, wherein the determination of the user intent is based at least in part on a previous interaction of the user with the second application agent.

Example 38: The method of example 1, wherein the action output comprises multiple executable instructions for the device.

Example 39: The method of example 38, wherein the multiple executable instructions are configured to cause the one or more processors to perform the multiple executable instructions in sequence, with at least one of the multiple executable instructions dependent on at least one other of the multiple executable instructions.

Example 40: The method of example 38, wherein the multiple executable instructions are configured to be executed using a plurality of applications available to the one or more processors, and the multiple executable instructions comprise a first instruction for execution using a first application of the plurality of applications available to the one or more processors, and a second instruction for execution using a second application of the plurality of applications available to the one or more processors.

Example 41: An electronic device comprising one or more processors and a memory storing instructions that, when accessed by the one or more processors, cause the one or more processors to execute any one of the methods of examples 1-40.

Example 42: A non-transitory, computer-readable medium storing instructions that, when accessed by one or more processors, cause the one or more processors to execute any one of the methods of examples 1-40.

Example 43: A computer program product comprising instructions that, when accessed by one or more processors, cause the one or more processors to execute any one of the methods of examples 1-40.

### Conclusion

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

Although concepts of exposing application functionality using system-level LLM agent services have been described in language specific to techniques and/or systems, it is to be understood that the subject of the appended claims is not necessarily limited to the specific techniques or methods described. Rather, the specific techniques and methods are disclosed as example implementations for exposing application functionality using system-level LLM agent services.

What is claimed is:

1. A method comprising:
accessing, by one or more processors, an application running on a device;
generating, by the one or more processors and based on one or more parameters of the application, an application agent, wherein the application agent is instantiated within the application, the instantiation comprising an interface within the application;
receiving, by the one or more processors via the application agent, an input prompt, the input prompt comprising a plurality of words in a natural-language format;
providing, by the one or more processors, the input prompt as an input for one or more large language models (LLMs);
receiving, by the one or more processors, an inference output of the one or more LLMs, the inference output indicative of an intent of the input prompt; and
causing, by the one or more processors and based on the intent of the input prompt, the device to perform an action output.

2. The method of claim 1, wherein the input prompt is generated at least in part by the one or more LLMs.

3. The method of claim 1, further comprising generating, by the one or more processors, a second output based on the action output, wherein the second output is provided through the application agent.

4. The method of claim 1, further comprising:
accessing, by the one or more processors, a second application; and
generating, by the one or more processors and based on one or more parameters of the second application, a second application agent, wherein:
the second application agent is instantiated within the second application, the instantiation comprising an interface within the second application; and
the interface within the second application includes the application agent.

5. The method of claim 1, further comprising determining, by the application agent, one or more limitations of the action output, the one or more limitations based on:
a plurality of available functions of the application; and
a permission set of the application comprising a list of allowed resources of the device available for access by the application.

6. The method of claim 1, further comprising:
accessing, by the application agent, the one or more LLMs through an application programming interface (API) of the application; and
limiting, by the application agent, a functionality of the one or more LLMs based on one or more permissions of the application.

7. The method of claim 1, wherein the action output performs at least one functionality of the application.

8. The method of claim 1, wherein the action output comprises at least one functionality of at least one outside application, the outside application being different than the application in which the application agent is instantiated.

9. The method of claim 1, wherein the input prompt is generated at least in part by the application agent.

10. The method of claim 1, further comprising determining, by the application agent, a user intent, wherein the input prompt is based on the user intent.

11. The method of claim 1, wherein the input prompt is a product of prompt engineering, the prompt engineering comprising generation of an optimized input prompt based on:
receiving, by the one or more LLMs, a plurality of training input prompts;
generating, by the one or more LLMs, a plurality of training action outputs, each of the plurality of training action outputs associated with a corresponding one of the plurality of training input prompts;
comparing each of the plurality of training action outputs with a threshold value; and
selecting, based on the comparison of each of the plurality of training action outputs with the threshold value, one of the plurality of training input prompts as the optimized input prompt.

12. The method of claim 1, wherein causing the device to perform the action output comprises using a functionality of one or more applications accessible to the device.

13. The method of claim 1, wherein the action output is generated at least in part by the one or more LLMs.

14. An electronic device comprising:
one or more processors; and
a memory storing instructions that, when accessed by the one or more processors, cause the one or more processors to perform operations comprising:
accessing, by the one or more processors, an application running on a device;
generating, by the one or more processors and based on one or more parameters of the application, an application agent, wherein the application agent is instantiated within the application, the instantiation comprising an interface within the application;
receiving, by the one or more processors via the application agent, an input prompt, the input prompt comprising a plurality of words in a natural-language format;
providing, by the one or more processors, the input prompt as an input for one or more large language models (LLMs);
receiving, by the one or more processors, an inference output of the one or more LLMs, the inference output indicative of an intent of the input prompt; and
causing, by the one or more processors and based on the intent of the input prompt, the device to perform an action output.

15. The electronic device of claim 14, wherein the input prompt is generated at least in part by the one or more LLMs.

16. The electronic device of claim 14, the operations further comprising generating, by the one or more processors, a second output based on the action output, wherein the second output is provided through the application agent.

17. The electronic device of claim 14, further comprising:
accessing, by the one or more processors, a second application; and
generating, by the one or more processors and based on one or more parameters of the second application, a second application agent, wherein:
the second application agent is instantiated within the second application, the instantiation comprising an interface within the second application; and
the interface within the second application includes the application agent.

18. The electronic device of claim 14, further comprising determining, by the application agent, one or more limitations of the action output, the one or more limitations based on:
a plurality of available functions of the application; and
a permission set of the application comprising a list of allowed resources of the device available for access by the application.

19. The electronic device of claim 14, further comprising:
accessing, by the application agent, the one or more LLMs through an application programming interface (API) of the application; and
limiting, by the application agent, a functionality of the one or more LLMs based on one or more permissions of the application.

20. One or more non-transitory computer readable media instructions storing instructions that, when accessed by one or more processors, cause the one or more processors to execute operations comprising:
accessing, by one or more processors, an application running on a device;
generating, by the one or more processors and based on one or more parameters of the application, an application agent, wherein the application agent is instantiated within the application, the instantiation comprising an interface within the application;
receiving, by the one or more processors via the application agent, an input prompt, the input prompt comprising a plurality of words in a natural-language format;
providing, by the one or more processors, the input prompt as an input for one or more large language models (LLMs);
receiving, by the one or more processors, an inference output of the one or more LLMs, the inference output indicative of an intent of the input prompt; and
causing, by the one or more processors and based on the intent of the input prompt, the device to perform an action output.
